(19) United States
(12) Patent Application Publication
(10) Pub. No.: US 2026/0011510 A1
(43) Pub. Date: Jan. 8, 2026

(54) ELECTRODE, ELECTROLYTE, CAPACITIVE ELEMENT, CAPACITOR AND PROCESSES OF MANUFACTURING OR MODIFYING OR IMPREGNATING AN ELECTRODE

(71) Applicant: TDK Electronics AG, München (DE)

(72) Inventors: Fabio Augusto BUENO DE CAMARGO MELLO, München (DE); Sebastian SCHÖLL, Röhrmoos (DE)

(21) Appl. No.: 19/034,883

(22) Filed: Jan. 23, 2025

(30) Foreign Application Priority Data
Jul. 2, 2024 (DE) 102024118704.2

(51) Int. Cl. H01G 9/052; H01G 9/02; H01G 9/035

(52) U.S. Cl. CPC H01G 9/052; H01G 9/035; H01G 9/02

(57) ABSTRACT

According to the application, an electrode is provided having a substrate and a sintered body on a first main surface of said substrate. The substrate comprises a first valve metal. The sintered body comprises merged or sintered particles that comprise a second valve metal. The first main surface of the substrate is surface-modified

### CROSS-REFERENCE TO RELATED APPLICATIONS

This application claims priority to and the benefit of German Application No. 102024118704.2, filed Jul. 2, 2024, which is incorporated by reference in its entirety. This application is also related to U.S. application Ser. No. 18/787,685, filed Jul. 29, 2024, and entitled “Electrode, Electrolyte, Capacitive Element, Capacitor and Processes Of Manufacturing Or Modifying Or Impregnating An Electrode,” which is incorporated by reference in its entirety.

### FIELD OF THE INVENTION

Electrode, electrolyte, capacitive element, capacitor and processes of manufacturing or modifying or impregnating an electrode.

### BACKGROUND OF THE INVENTION

The present application concerns an electrode, an electrolyte, a capacitive element, a capacitor and a processes of forming or modifying or impregnating an electrode.

Improving capacitors in general and electrolyte capacitors in particular can present challenges. In particular, trying to improve the volume efficiency of a capacitor can cause secondary problems.

For example, the inventors of the present invention have found that at least some capacitors with high volume efficiency tend to have problems. In particular, one of said problems may be reduced lifetime under the same operating conditions as less volume-efficient capacitors.

Other challenges may arise in particular when sintered anodes or similar are used for capacitors.

Accordingly, it is an aim of the present application to provide electrodes or capacitors that solve one of the above-mentioned problems or problems described below, at least partially.

### SUMMARY OF THE INVENTION

The electrodes, electrolytes, capacitors or capacitive elements or processes of the independent claims each solve a problem that is addressed above or in the following at least partially. Advantageous embodiments are provided in the dependent claims.

In the following several features are disclosed which, when taken alone, can provide benefits such as those described above or other benefits that will be described below. However, particularly when combined, synergetic effects and additional benefits may be achieved.

According to a first embodiment, which may apply to all other embodiments in the following, but does not necessarily apply to all other embodiments, a sintered electrode is described.

In the most general sense, a sintered electrode is an electrode that has a sintered body. A sintered electrode can be used in a capacitor, preferably in an electrolytic capacitor. Preferably, the sintered electrode comprises a valve element. This may mean that it can comprise one or more valve elements.

One or more different types of particles which comprise or consist of a valve metal are sintered or merged together in the sintered body. “Merged” means here that particles in the sintered body are not loose but are incorporated in a solid and preferably porous structure of particles that are partly fused together with other particles. Such a sintered body of merged particles can be achieved in general by any means. In particular, it may be achieved by sintering of valve metal particles, i.e. by a heating or annealing step that merges or fuses the particles. This means that the term “sintered body” is not limited to a body of particles that have actually been sintered. Any other technique leading to similar merging of particles can form a sintered body despite, for example, no heat treatment being applied. However, sintering is the most preferred technique.

The inventors of the present invention have found that sintered electrodes, in particular when used as anodes, can help to increase the volume efficiency of a capacitor. In particular, an improved volume efficiency can be found when compared to etched electrodes. Electrodes, and in particular electrodes that are used as an anode are preferably passivated by an oxide layer.

Here and in the following “valve metals” are understood in the general technical sense and are not otherwise limited. For example, valve metals include at least aluminum, titanium, tantalum, niobium, tungsten, chromium, zirconium, hafnium, zinc, vanadium, bismuth, or antimony. Of these in particular aluminum, tantalum and vanadium are preferred. The most preferred valve metal used for electrodes for the embodiments disclosed here is aluminum.

According to an embodiment, the electrode can be a sintered bulk anode, which in this case means that the majority of the volume of the anode may consist of the sintered body or sintered material. In this case a sintered material block can be contacted by a lead terminal or similar.

According to an embodiment that is even more preferred with the other embodiments herein, the sintered anode may have a substrate. The substrate can in principle comprise or consist of any conductive material such as a metal or an alloy. Preferably the substrate also comprises or consists of a valve metal which may be addressed here as the first valve metal. The valve metal of the particles of the sintered body can in this case be addressed as a second valve metal. In both cases, the first valve metal and the second valve metal can be selected individually from the above-listed valve metals. Most preferably, both are the same. Even more preferably, both are aluminum.

The sintered body can be arranged on a main surface of the substrate. For example, and preferably, the substrate can be a platelet or foil and the sintered body can be a sintered layer that is arranged on said main surface of said foil. Even more preferred, two opposing main surfaces of the substrate foil can be covered by a sintered layer. Such a setup may allow for improved higher specific capacitance than can be reached by an etched anode, for example.

The inventors of the present invention have found that an electrode having a substrate and the sintered body as described above can, in some cases, lack adhesion between the sintered body and the surface. In such a case, the sintered body may delaminate from the substrate. This may occur for example during processing of the electrode foil, such as slitting, winding and cold-welding processes as well as during capacitor operation. Besides affecting the quality of the electrode and a capacitor built with it, the delaminated portions may also create gas during storage or operation of a capacitor. The delamination may create bare metal that is oxidized by an electrolyte, for example which creates gas. Such gas can lead to buildup of pressure in a capacitor which may destroy the capacitor.

To overcome this issue at least partially, the inventors surprisingly found that by surface-modifying the first main surface of the substrate, the sintered body arranged on said main surface may have improved adhesion. Thus, delamination can be better prevented.

According to an embodiment, the surface modification can increase the surface area or the roughness of the first main surface of the substrate. A point of comparison can be the unmodified substrate surface. The inventors think that an increased surface area can help to increase adhesion.

According to an embodiment, the surface modification may comprise protruding portions. Protruding portions may be any portion created by the surface modification that protrudes above an average level of the modified surface. According to a preferred variation of this embodiment, some protruding portions can be tip-shaped and/or rim-shaped. In a generalized way, the protruding portions can have, at least along one direction, a smaller thickness at the point facing furthest away from the substrate than at a point further towards the substrate.

According to an embodiment, the surface modification can comprise indentations into the substrate. For example, the indentations may have a concave shape. In particular, it may be preferred that these portions that indent into the substrate have a crater-like shape.

According to a modification of the above-described embodiment and the embodiment according to which the surface comprises indentations, the protruding portions can be rim portions or tip portions of the crater-like indentations.

The inventors have found that by having some or all of the above-described surface-morphological properties, adhesion can be improved. For example, the indentations may help to accommodate the particles. The protruding portions may provide portions of the modified substrate surface that get heated to the sintered temperature faster during a sintering procedure, which may simplify sintering of the sintered body onto the main surface.

Accordingly, in a generalized manner, it is also an embodiment of the present description that portions of the surface modification are configured to improve adhesion during sintering.

Forming said surface modification is not limited to any type of specific structure in the most general sense. Also, it is not limited to any type of method for producing said structure. In particular, the technique may, for example, include lithographic steps.

According to a preferred embodiment, the surface modification is, or is achieved by, a chemical or electrochemical surface etching. In particular, in valve metal-containing surfaces and, most preferably, in aluminum-containing surfaces, indentations can easily be etched therein by chemical or electrochemical means. The rim portions of the indentation can form protruding portions. Thus, a simple process for achieving a surface modification can be achieved.

The surface modification in general and also the etching in particular can be advantageous, as it may remove a natural oxide that has formed or impurities on the substrate surface, at least partially.

According to an embodiment, the surface roughness Rₐ of the surface-modified main substrate may be in the same order of magnitude as the particles of the sintered body. It may also be smaller. The term “same order of magnitude” can be understood in the general technical sese of the word. For example, this may mean that the average size of the structures on the surface the surface roughness Rₐ can be 0.1 to 10 times that of the average particle size used. Alternatively, or additionally the surface roughness can be in a size of 0.01 to 50 μm. More preferably it may be 0.1 to 50 μm, 0.5 to 10 μm or even 0.7 to 7 μm or 0.5 to 5 μm.

The inventors of the present invention have found that when the size of the structures on the surface is similar to that of the particles used for the sintered body, the adhesion can be preferable.

According to an embodiment, the particles of the sintered body have an average size of between 0.5 μm and 10 μm, such as 1 μm to 5 μm.

The inventors have found that this particle size for the particles of the sintered body helps to increase the volume efficiency of the electrode. The inventors have found further that particles of this size can be adhered well with the above-defined means. In particular the structures created by etching and/or the above surface roughness regime provides good adhesion for particles of this size.

According to a further embodiment, the content of the valve metal in the substrate can be 98 wt % or more, such as 99 wt % or more or even more preferably 99.7 wt % or more or even more preferably 99.9 wt % or more. These values are particularly relevant for the valve metal aluminium. Previously, high purity valve metal substrates often had to be used for producing sintered electrodes. These are more expensive to fabricate than the above-described substrates which have a lower purity. In addition, the inventors have found that the lower purity of the substrates may help to surface modify the substrate.

According to an embodiment, the purity of the valve metal in the substrate for the above-mentioned reasons can be below 99.99 wt % and more preferably below 99.9 wt %. Accordingly, for example a range of 98 wt % to 99.90 or 99.99 wt % can be used. Alternatively, the above-mentioned values can replace the “98%” in this range. In particular for a range of 99.7 wt % to 99.99 wt % or in particular of 99.7 wt % to 99.90 wt % the inventors have found that the impurity levels are good for the surface modification but also not too high and other drawbacks of impurities are reduced.

The next embodiment is also preferably used for an electrode having a sintered body as described above. However, this approach can also be applied to any other type of electrode that can be used in an electrolytic capacitor. An electrode can have defects or crack sites for several reasons. In these defects or crack sites the oxide layer that is preferably formed on the surface of an electrode may be partially lacking.

The inventors have found out that the above-described sintered bodies are particularly prone to forming the above-described cracks. For example, cracks may be formed as a result of the manufacturing process of the electrode. For example, in the case of a foil electrode with a foil-like substrate and a sintered body during process steps such as slitting, winding and cold-welding processes, as well as during later capacitor operation, cracks or partial delamination of the sintered body may occur.

According to the present embodiment such cracks, or any site that at least partially lacks an oxide layer, can be at least partially passivated using a passivating compound.

If not passivated quickly, gases may form at those sites, during operation or also during passive storage, due to chemical reactions with bare metal. Thus, unwanted excess gas can form in a capacitor which may destroy said capacitor. Venting systems may be used to accommodate for such gas formation. Accordingly, passivating said sites helps to reduce gas generation and may also help to avoid elaborate gas compensation means.

Previously the high energy density or capacitive density of a sintered anode foil combined with the high amount of surface cracks causes a high energy consumption or leakage current until the damaged electrode has sufficient passivating oxide. Typically with a state of the art electrode, multiple repairs are required during a capacitor's lifetime, limiting the applicability of this technology due to the resulting high hydrogen gas generation. These disadvantages may be reduced by using a passivating compound.

As is described below in more detail, said substances can be applied either separately before assembling a capacitor directly on the anode or on a capacitive element such as a winding element, or they can be applied as a component in the electrolyte itself.

The inventors have found that the passivating compounds can reduce the gas generation prior and during oxide formation that can take place from the liquid electrolyte. This means that, besides a passivating effect by the compounds themselves, they can additionally facilitate the closing of sites by a combination of the passivating compound and oxides that are forming.

The passivating compound is generally not limited and can be applied in the form of a molecular or particle-containing compound or composite.

According to an embodiment, phosphor-containing compounds or silicon-containing compounds can be used as the above-described partially passivating compound.

For example, according to an embodiment, the silicon-containing compound can be provided in a form that comprises particles. For example, such particles can contain silicon oxide.

According to an embodiment, application of a passivating compound can also reduce the demand for a high purity level for valve metals in the electrodes. This can apply to the substrate and/or the sintered body in the case of a sintered electrode having a substrate and a sintered body. For example, a passivating compound may help when using valve metal purity of 99.7 or 99.8 wt % or above, such as of 99.7 to 99.99 wt % or 99.7% to 99.0 wt %. The inventors have found that passivating components can help to reduce leakage current in combination with the a reduced purity. This holds true for both the substrate and the sintered body. In both cases the effect is particularly pronounced for A1.

According to an embodiment it can be preferred to combine surface modification and the passivation, as both can help to reduce free metal surface in a complementary manner. Also both means may help to use less pure metals.

In addition the inventors have found that the thickness of a separator may be reduced through better passivation by using a passivating compound in a capacitor setup. Volume efficiency can be increased thereby. For example this may help to reduce the thickness of a separator to 44 μm or below, or to 40 μm or below or even to 35 μm or below. These values may be the total thickness of the separator between anode and cathode foil. Here and in this specification the term “separator” may address the functional unit separating cathode and anode. It is not limited to a single-layered separator, but may also include separator constructions having two or more layers.

According to a further embodiment, an electrode is described that has an impregnation on at least a portion of its surface. Again, the electrode is preferably an electrode having a sintered portion that is impregnated. However, it is not limited to such sintered electrodes. The impregnation is configured to increase the wettability of the electrode or the impregnated portion by an electrolyte. The inventors have found that by increasing the surface area of the electrode, for example, and in particular by having a sintered body, the wettability of the electrode by the electrolyte becomes increasingly important.

The inventors have found that the high degree of compactness and density of the sintered electrodes and the oxide grown thereon can make wetting by an electrolyte difficult, in particular for electrolytes with higher viscosity. This is improved by the impregnating compound.

According to an embodiment, silanes can act as a wettability-improving impregnation. The same holds true for polyethylene oxides, sulfonates or anionic surfactants. Silanes, polyethylene oxides, sulfonates or anionic surfactants may be used individually or a mixture of one or two of these can be used as well.

The above-described approach of increasing the wettability can preferably also applied to the surface modification described above and also to the reduction of non-passivated sites in a complimentary manner.

Furthermore, electrolytes for electrolytic capacitors are described as further embodiments.

According to a first embodiment, an electrolyte is described that comprises a compound that is configured to adsorb to crack sites of an electrode or sites of an electrode that at least partially lack an oxide layer. The compound is configured to at least partially passivate said sites. The electrolyte, which may be used in an electrolytic capacitor, can comprise the above-described at least partially passivating compounds.

The above-described advantages also apply here.

According to an embodiment, the passivating compound can be, as described above, a phosphor-containing or silicon-containing compound either in molecular or in particle-like configuration. In the electrolyte in the latter case, this can be an emulsion including said particles. For example, particles comprising silicon oxide can be used with a concentration ranging of 0.1 to 5 wt %, such as 0.5 to 1.5 wt %.

For example, the electrolyte may be combined in a capacitor with an above-described electrode, and preferably with a sintered electrode. Accordingly the above-described partially passivated electrode can be formed in situ by the electrolyte. In many cases part of the passivating compound may be found in the electrolyte even after adsorption to the electrode.

According to a further embodiment, an electrolyte for an electrolytic capacitor is described that has an impregnating compound that is configured to impregnate a portion of the surface of an electrode. Said impregnating compound is configured to increase the wettability of the surface of the electrode by the electrolyte. It is further configured to adsorb on the surface of the electrode. For example, it can be an above-described silane, polyethylene oxide, sulfonate and/or anionic surfactant that is added to the electrolyte.

According to an embodiment the concentration of the impregnating compound in the electrolyte can be 10 to 200 ppm per weight, such as 15 to 50 ppm. Generally, but in particular for the listed examples of an impregnating compound, the inventors have found that for this concentration range the wettability by the electrolyte could be considerably improved.

For example, the electrolyte may be combined in a capacitor with an above-described electrode, and preferably with a sintered electrode. Accordingly, the above-described impregnated electrode can be formed in situ by the electrolyte. In many cases part of the impregnating compound may be found in the electrolyte even after adsorption to the electrode.

The impregnating compound and the passivating compound can be added to an electrolyte together.

According to a further embodiment that can be independent of the other embodiments above, but which can also be combined with them in an advantageous manner, an electrolyte for an electrolytic capacitor is described that, in a state before wetting a separator or wetting a winding element, has a conductivity of 660 μS/cm or below at a temperature of 30° C. The inventors of the present invention have found that a conductivity of 660 μS/cm or below can be advantageous for sintered electrodes and can help to reduce the thickness of a separator that is soaked with the electrolyte.

Having a lower conductivity can reduce generation of localized heat during self-healing or reduce the need for passivating processes of damaged sintered bodies, such as described above. Until the present invention, highly conductive electrolytes were often used in which surface repair processes generated a high-density localized heat, by which a very high leakage current was obtained.

According to a variation of the above embodiment, the electrolyte can have a water content of 1% to 10%. The inventors of the present invention have found that such a high water content of the electrolyte can help to reduce the thickness of the separator paper.

According to a further embodiment, a capacitive element is described. The capacitive element may be configured to store electric charges during operation of a capacitor. For example, the capacitive element can be configured to be charged and discharged during operation of a capacitor. For example, the capacitive element can comprise a cathode and an anode. The cathode and the anode can be electrically contacted by electrically conductive elements, such as wires or leads. The cathode and the anode are not limited in general. Preferably the anode can have the properties of the above-described electrode.

According to an embodiment that may be preferred for the other embodiments, the capacitive element can be a winding element in which the anode and the cathode are wound. For example, the winding element can be a cylindrical winding element or a flattened winding element.

According to an embodiment that may also be preferred for the other embodiments, the winding element can be configured for an electrolytic capacitor. In this case an electrolyte is arranged between anode and cathode. For example a separator that is drenched with or soaked with the electrolyte may be arranged between anode and cathode. The separator is not limited except it should be configured to be soaked with or drenched in an electrolyte and it should not be electrically conductive. The separator may comprise or consist of a cellulose-based material such as paper. In an electrolytic capacitor it may be preferred that the anode has an oxide on its surface that provides an at least partial chemical and electrical separation between anode and electrolyte.

The electrolyte is generally not limited. Yet the above electrolytes may have the features of the above-described electrolytes, which leads to the described advantages.

According to an embodiment a capacitive element can be described wherein a separator is soaked with an electrolyte that has a maximum conductivity of 660 μS/cm and, preferably, in addition a content of 1 to 10% of water. In this case, a thickness of the separator can be 44 μm or below. For example the thickness of the separator can even be 40 μm or below and even 35 μm or below.

According to a further embodiment, a capacitor having a capacitive element is provided. The capacitive element may be one of the capacitive elements described above or may have their combined features. Alternatively or additionally, the capacitor can have any of the above-described electrodes as an anode. Alternatively or additionally the capacitor can have any electrolyte, but preferably it has one of the above-described electrolytes.

According to further embodiments, processes of manufacturing electrodes or of treating electrodes are described in the following. As far as applicable, the processes can have the above-described features, which are explained for the electrodes or the electrolytes.

According to an embodiment, a process of manufacturing an electrode is described. First, a substrate is provided. The substrate used here comprises or consists of a first valve metal. For example, it may comprise or mainly consist of aluminum. For example, it may have the above-described purity levels of the substrate. In a further step, the main surface of said substrate is modified in order to receive a surface-modified main surface of the substrate. For example, as described above, said surface modification can be a formation of protrusions and/or indentations and it also may increase the surface roughness and, preferably, the adhesion towards the sintered body. As a next step in the process, a sintered body is formed on said surface-modified main surface. The sintered body comprises or consists of merged particles that comprise or consist of a second valve metal. Here the partial process of forming said sintered body is not limited and can be any suitable process. For example, the formation of the sintered body can include sintering of particles at a temperature of 400 to 660° C. The particles can comprise aluminum as a main component, for example. For example, forming the sintered body can also include application of a slurry comprising said particles. The slurry may subsequently be sintered. The particles in general comprise a second valve metal and preferably aluminum.

As described above, surface modification can be achieved by any suitable means such as lithography or any type of etching. Most preferably, chemical or electrochemical etching is used.

According to a further embodiment, a process is described in which at least a portion of a sintered body is modified by adsorbing a compound to crack sites or at least sites that at least partially lack an oxide layer. The compound is configured to passivate said sites at least partially. The above-described properties for such a compound may apply here. This process may either be conducted on the electrode as formed or by having the at least partially passivating compound in the electrolyte, or a combination of both.

According to a further embodiment, a process of impregnating at least a portion of an electrode and preferably of a sintered electrode is described. This impregnation can be performed by applying an impregnating compound which may be the impregnating compound as described above. The impregnating compound is configured to increase the wettability of the surface of the electrode by an electrolyte. Also this process can be performed either prior to building the electrode into a capacitor or by having the impregnating compound in the electrolyte, or a combination of both.

Further advantageous embodiments and further embodiments of the electrode or the capacitor and a method of producing such electrodes or capacitor may become apparent from the following exemplary embodiments described in connection with the figures. However, please note that the invention is not limited to said exemplary embodiments. Further, said exemplary embodiments are at least partially depicted in figures showing schematic drawings. These schematic drawings are not true to scale, and absolute and relative dimensions can be depicted in a distorted manner. Rather, individual elements may be shown exaggeratedly large for better representability or better understanding. Accordingly, no absolute or relative dimensions can be taken from the schematic depictions unless otherwise indicated. Elements that are identical, similar or have the same effect are denoted by the same reference signs in the figures.

### BRIEF DESCRIPTION OF THE DRAWINGS

FIG. 1 shows a schematic sketching of a process of surface modification.

FIG. 2 shows a schematic cross-section of a first embodiment of an electrode.

FIG. 3 shows a cracked embodiment of an electrode.

FIG. 4 shows an intermediate stage of at least partially passivating an electrode.

FIG. 5 shows an at least partially passivated embodiment of an electrode.

FIG. 6 schematically shows the wetting behaviour of an unimpregnated electrode.

FIG. 7 shows the wetting behaviour of an impregnated electrode.

FIG. 8 shows an exemplary embodiment of a capacitor.

### DETAILED DESCRIPTION OF THE DRAWINGS

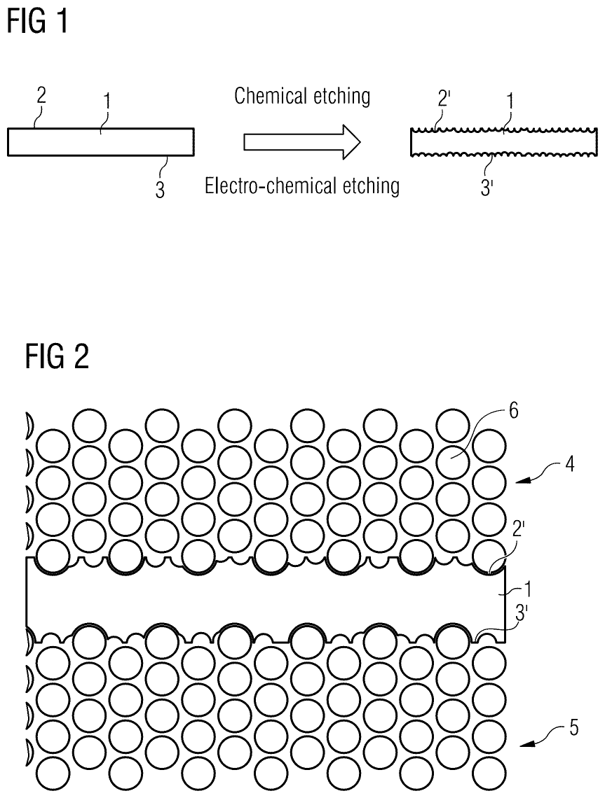

In FIG. 1 a schematical cross-section of a process of forming a surface-modified substrate is shown. On the lefthand side of the depiction a substrate 1 having a first main surface 2 and a second main surface 3 is shown. The substrate 1 consists of a material comprising 99.7 wt % or more aluminum. Subsequently it is either chemically or electrochemically etched. In particular, electrochemical etching can be performed with a process similar to the formation of cathodes in forming an electrolytic capacitor. Thereby, a modified first main surface 2′ is formed from the first main surface 2. A modified second main surface 3′ is formed from the second main surface 3. The formed structure comprises protrusions which are tip-shaped or rim-shaped, as well as indentations into the substrate which are concave or bowl-shaped.

A chemical etching can be carried out in HCl or NaOh solution. The concentration can be between 0.5 mol/1 and 4 mol/l, such as preferably 1 mol/l. The etching can be carried out at temperatures of 60° C., for example but also at other temperatures. Electrochemical etching can be carried out at basically the same conditions and under current densities of 100 mA/cm² to 3 A/cm². The conditions can be chosen or adapted such as to produce the described structures.

In a further step, the result of which is depicted in FIG. 2, a first sintered body 4 and a second sintered body 5 can be formed on the first and the second modified main surfaces 2′ and 3′. The sintered bodies 4 and 5 are formed for aluminum particles which are provided in a slurry. The slurry is deposited onto the modified substrate surfaces 2′ and 3′. Subsequently, the slurry can be debindered and sintered. The sintering is performed at a temperature between 400 and 660° C. The particles in the sintered bodies 4 and 5 become merged together by the sintering. The particles are aluminum-based particles with an aluminum content of 99 wt % or above. Not explicitly depicted here is that the aluminum sintered bodies can be passivated by oxidizing. Thereby an insulating surface oxide is formed.

By having the above-described surface modification, adhesion of the sintered body to the surface can be improved. The inventors attribute this to an increased surface roughness and potentially also to removal of the natural oxide on the substrate and of potential impurities. In addition, the inventors have found that the above-described comparatively low purity of the substrate simplifies forming of the surface modification.

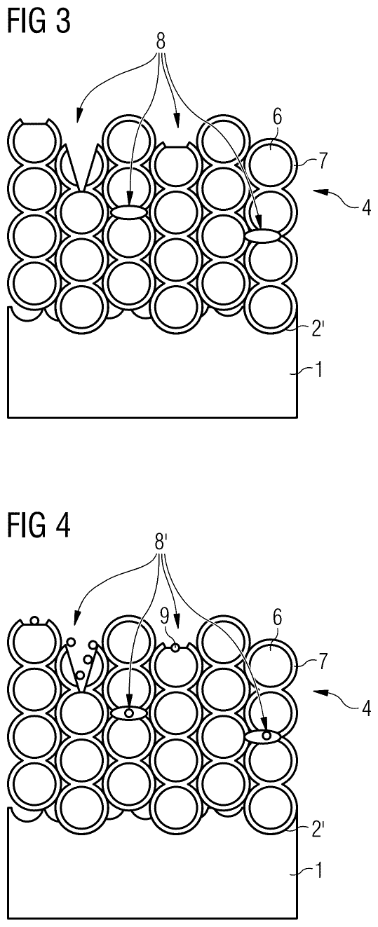

In FIGS. 3 to 5, a process of passivating crack sites is shown. FIG. 3 shows a substrate 1 with a surface modified main surface 2′ as explained above for FIGS. 1 and 2. A sintered body 4 is formed on the substrate 1. The sintered body is comprised of merged particles 6. The surface oxide 7 is explicitly depicted here. The sintered body may be damaged during the fabrication steps of forming a capacitor, such as slitting, winding and cold-welding. Crack sites 8 can be formed thereby. As is depicted in FIG. 4, components which are configured to at least partially passivate those crack sites 8 can be adsorbed to these crack sites 8. This can either be done in an electrolyte in the capacitor or, in addition or instead, it can be done prior to addition of the electrolyte. Here, the passivating compound 9 is formed from silicon oxide particles. These can be present in an emulsion like-electrolyte or applied by a separate emulsion before potting of a capacitor. Such silicon oxides or alternatively phosphor-containing compounds or particles adhere to the crack sites and form modified crack sites 8′ as shown in FIG. 4. This already partially provides a passivation to those crack sites. This may reduce the formation of gases from the reaction of the electrolyte in the assembled capacitor.

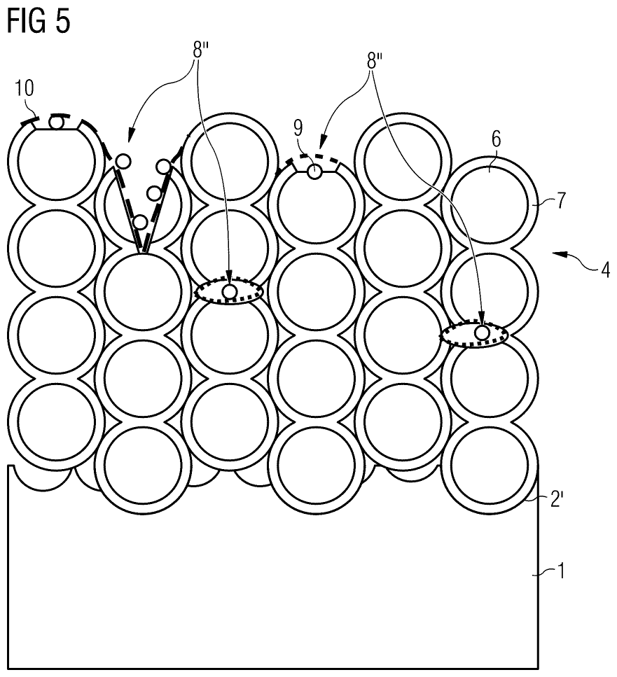

As is shown in FIG. 5, upon application of an adequate solution or in particular an electrolyte that contains some water, a partial oxide 10, indicated by the dashed lines, can be formed in addition to the silicon particles 9. This oxide can at least partially and additionally passivate said crack sites. The inventors have found that by using an at least partially passivating compound such as silicon oxide, the passivation by the oxide newly formed in the electrolyte or by another separate technique can better passivate the crack sites. The crack sites here have the reference sign 8″ indicating increased passivation.

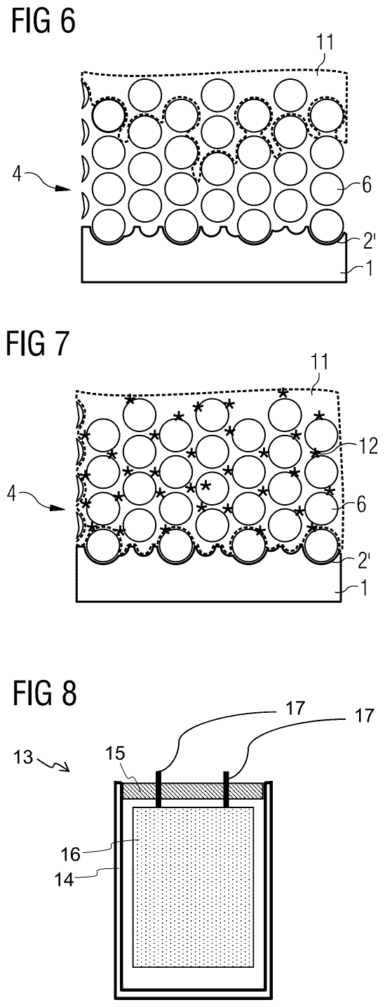

In FIG. 6, a sintered electrode which is immersed in an electrolyte is depicted. In this case, the electrolyte 11 has problems in fully wetting the entire sintered body.

To overcome this, the inventors, as depicted in FIG. 7, found that an impregnating compound 12 can be adsorbed to the particle 6 of the sintered body. This can be done either before potting the capacitor or by adding such a compound to the electrolyte. In the case of an electrolyte, the concentration of the impregnating compound can be 10 to 200 ppm per weight. As depicted, the wetting by the electrolyte is improved by which a larger portion of the capacitor can be used for capacitive interactions.

In FIG. 8 a capacitor 13 is shown in schematic cross-section. The capacitor 13 has a case 14 that is closed by a cover 15. Inside this housing formed by the case 14 and the cover 15, a winding element 16 is assembled. Though not explicitly depicted, the winding element comprises a cathode which is not limited. Furthermore, it comprises an anode which can be any of the above-described anodes. In addition, two lead contacts 17 are provided that contact anode and cathode. Furthermore, anode and cathode in the winding element are separated by a separator paper. The separator paper is soaked in the electrolyte. Optionally, the electrolyte can contain the above-described substances for a passivation of cracks and for increasing wettability. Furthermore, the electrolyte used here can preferably have a conductivity of 660 μS/cm or below and has a water content of 1 to 10%. Thus, the thickness of the separator paper can be reduced to 40 μm or even below.

### REFERENCE SIGN LIST

1 substrate
2 first main surface
2′ modified first main surface
3 second main surface
3′ modified second main surface
4 first sintered body
5 second sintered body
6 particles
7 oxide
8 crack site
9 passivating compound
10 partial oxide
11 electrolyte
12 impregnating compound
13 capacitor
14 case
15 cover
16 winding element
17 lead contact

1-36. (canceled)

37. An electrolyte for an electrolytic capacitor, comprising:
a compound that is configured to adsorb to crack sites of an electrode or sites of the electrode that at least partially lack an oxide layer, the compound being configured to at least partially passivate the sites.

38. The electrolyte according to claim 37, wherein the compound that is configured to adsorb to crack sites is a phosphor-containing compound or a silicon-containing compound.

39. The electrolyte according to claim 37, wherein the crack sites are in a sintered body of the electrode, the compound is configured to passivate the crack sites in the sintered body.

40. The electrolyte according to claim 37, wherein the compound that is configured to adsorb to crack sites is configured to facilitate the closing of crack sites by a combination of the adsorption of the compound and formation of an oxide.

41. The electrolyte according to claim 37, wherein the compound that is configured to adsorb to crack sites is a molecular compound.

42. The electrolyte according to claim 38, wherein the compound that is configured to adsorb to crack sites is a particle-containing compound or composite.

43. The electrolyte according to claim 42, wherein the concentration of the compound in the particle-containing compound or composite is 0.1 to 5 wt %.

44. An electrolyte for an electrolytic capacitor, comprising:
an impregnating compound that is configured to impregnate a portion of the surface of an electrode, the impregnating compound being configured to increase the wettability of the surface of the electrode by the electrolyte, when adsorbed to the surface of the electrode.

45. The electrolyte according to claim 44, wherein a concentration of the impregnating compound is 10 to 200 ppm per weight.

46. The electrolyte according to claim 44, wherein a concentration of the impregnating compound is 15 to 50 ppm per weight.

47. The electrolyte according to claim 44, wherein the impregnating compound is configured to impregnate a portion of the surface of a sintered body.

48. The electrolyte according to claim 44, wherein the impregnating compound is selected from a silanes, polyethylene oxides, sulfonates or anionic surfactants.

49. An electrolyte for an electrolytic capacitor, wherein in a state before wetting a separator or a winding element, the electrolyte has a conductivity of 660 μS/cm or below at a temperature of 30° C.

50. The electrolyte according to claim 49, wherein the electrolyte has a water content of 1% to 10%.
